(19) United States
(12) Patent Application Publication
(10) Pub. No.: US 2026/0248222 A1
(43) Pub. Date: Aug. 27, 2026

(54) PROCESSING METHOD FOR SPRAY COATING NON-ADHESIVE THERMOPLASTIC FALSE EYELASHES

(71) Applicant: Qingdao Homay Eyelashes Co., Ltd., Qingdao (CN)

(72) Inventor: Mingtao Zhang, Qingdao (CN)

(21) Appl. No.: 19/202,217

(22) Filed: May 8, 2025

(30) Foreign Application Priority Data
Feb. 24, 2025 (CN) 202510204465.7

(51) Int. Cl. A41G 5/02

(52) U.S. Cl. CPC A41G 5/02

(57) ABSTRACT

A processing method for spray coating non-adhesive thermoplastic false eyelashes is provided, which includes the following steps: (1) preparing a thermal spray eyelash filament coil; (2) preparing thermal spray eyelash filaments; (3) producing thermal spray eyelash filament sheets; (4) overlaying thermal spray eyelash filament A, B, C sheets in sequence to obtain a semi-finished eyelash D sheet, pressing the semi-finished eyelash D sheet with a thermal conductive blade of a thermal shaping machine and heating to form an eyelash band, cutting off a lower of the eyelash band with the blade to obtain the spray coating non-adhesive thermoplastic false eyelashes. The present disclosure has the following beneficial effects: significantly reducing the amount of various resin adhesives used for bonding; improving the softness of eyelash band; improving the eyelash band yield and greatly shorten the drying time; standardizing a thickness and symmetry of the eyelash band to enhance user comfort.

### CROSS-REFERENCE TO RELATED APPLICATIONS

This application claims priority to Chinese Patent Application No. 202510204465.7, filed on Feb. 24, 2025, which is hereby incorporated by reference in its entirety.

### TECHNICAL FIELD

The present disclosure relates to the field of beauty and makeup technologies, and in particular, to a processing method for spray coating non-adhesive thermoplastic false eyelashes.

### BACKGROUND

False eyelashes are artificial eyelashes used to beautify the eyes, usually by lengthening and thickening the eyelashes, making the eyes look bigger, brighter, fuller, and livelier. False eyelashes have a long history, with records dating back to 2000 BC in ancient Egyptian and Roman literature. The materials used to make false eyelashes include plastic, cotton, feathers, and other materials, and the effects displayed (such as exaggerated stage effects) vary with the use of different materials to make false eyelashes.

The existing eyelash band thread is generally composed of cotton thread, fish silk thread, nylon thread, and various resin adhesives. The traditional eyelash band threads have two stalk threads, a main stalk thread and a back stalk thread. Multiple clusters of eyelashes composed of various hair are placed between the main stalk thread and the back stalk thread, and then irrigated with glue to bond and fix them together. In addition to its function of fixing eyelashes, the eyelash band thread is also the part that directly contacts human skin. In existing technology, two stalk threads are used to bond multiple eyelashes between them with glue. This method forms a thicker eyelash band thread, which makes it easier for the wearer to feel foreign objects and affects aesthetics when wearing. Furthermore, this adhesive coating eyelash band thread will become hard and easily break if stored for too long (more than 6 months), making it unsuitable for wearing. Finally, the production process of the eyelash band thread with adhesive is complex and cumbersome, and the drying time after applying the adhesive is at least 6-24 hours.

### SUMMARY

The present disclosure aims to improve the existing problems in the prior art, and discloses a processing method for spray coating non-adhesive thermoplastic false eyelashes.

In a first aspect, the present application provides a processing method for spray coating non-adhesive thermoplastic false eyelashes, including with the following steps:
(1) preparing a thermal spray eyelash filament coil
after a hot pressing machine pulling out eyelash silk threads arranged in a straight line, performing a first cooling treatment, performing a thermal spraying on the eyelash silk threads arranged in a straight line through high-pressure multi-nozzles in a closed thermal spraying device; performing a second cooling treatment after the spraying is completed, and then the thermal spray eyelash filament coil is harvested by a coiling machine;
(2) preparing thermal spray eyelash filaments
cutting, segmenting, and sharpening the thermal spray eyelash filament coil obtained in step (1) to make a bundle of thermal spray eyelash filaments with a length of 5 centimeters;
(3) producing thermal spray eyelash filament sheets
bonding the thermal sprayed eyelash filaments with a fixed double-sided tape to form the thermal spray eyelash filament sheets; one side of the fixed double-sided tape is semi-finished thermal sprayed false eyelashes, and the other side thereof is a thermal sprayed eyelash filaments waste material;
where the thermal spray eyelash filament sheets consist of thermal spray eyelash filament A sheet, thermal spray eyelash filament B sheet, and thermal spray eyelash filament C sheet;
angles between thermal spray eyelash filaments of the thermal spray eyelash filament A sheet and the fixed double-sided tape are 45°;
angles between thermal spray eyelash filaments of the thermal spray eyelash filament B sheet and the fixed double-sided tape are 90°;
angles between thermal spray eyelash filaments of the thermal spray eyelash filament C sheet and the fixed double-sided tape are 135°;
(4) producing spray coating non-adhesive thermoplastic false eyelashes
overlaying thermal spray eyelash filament A, B, and C sheets in sequence to obtain a semi-finished eyelash D sheet, pressing down the semi-finished eyelash D sheet with a thermal conductive blade of a thermal shaping machine and heating for 1-3 seconds, a part of the semi-finished eyelash D sheet pressed down along the blade forms an eyelash band; cutting off the thermal sprayed eyelash filaments waste material along a underside of the eyelash band to obtain the spray coating non-adhesive thermoplastic false eyelashes;
a melting point of a sprayed material on surfaces of the eyelash filaments is T, 120° C.≤T≤180° C.; and a temperature of the thermal conductive blade of the thermal conductive shaping machine is set to [T, T+10];
the thermal conductive blade of the thermal shaping machine has a width of 1-3 millimeters.

In some embodiments of the present disclosure, the eyelash silk threads are made of a mixture of PET and PBT materials;
the sprayed material of the closed thermal spraying device is liquid-state polyurethane with a melting point of 120-180 degrees.

In some embodiments of the present disclosure, the thermal spray eyelash filament A sheet is strip eyelash type thermal spray eyelash filament A sheet;
the thermal spray eyelash filament B sheet is strip eyelash type thermal spray eyelash filament B sheet;
the thermal spray eyelash filament C sheet is strip eyelash type thermal spray eyelash filament C sheet;
the semi-finished eyelash D sheet is strip eyelash type semi-finished eyelash D sheet; or
the thermal spray eyelash filament A sheet is a segmented eyelash type thermal spray eyelash filament A sheet;
the thermal spray eyelash filament B sheet is a segmented eyelash type thermal spray eyelash filament B sheet;
the thermal spray eyelash filament C sheet is a segmented eyelash type thermal spray eyelash filament C sheet;
the semi-finished eyelash D sheet is a segmented eyelash type semi-finished eyelash D sheet.

In a second aspect, the present application provides a processing method for spray coating non-adhesive thermoplastic false eyelashes, including the following steps:
S1: producing eyelash filament sheets
bonding eyelash filaments with a fixed double-sided tape to obtain the eyelash filament sheets; one side of the fixed double-sided tape is semi-finished false eyelashes, and the other side thereof is an eyelash filaments waste material;
where the eyelash filament sheets consist of spray eyelash filament A sheet, spray eyelash filament B sheet, and spray eyelash filament C sheet;
angles between eyelash filaments of the eyelash filament A sheet and the fixed double-sided tape are 45°;
angles between eyelash filaments of the eyelash filament B sheet and the fixed double-sided tape are 90°;
angles between eyelash filaments of the eyelash filament C sheet and the fixed double-sided tape are 135°;
S2: producing thermal spray eyelash filament A/B/C sheets
performing thermal spraying at corresponding positions on two sides of the eyelash filament B sheet obtained in step S1 with high-pressure multi-nozzles of a closed thermal spraying device to form the thermal spray eyelash filament B sheet;
performing thermal spraying at corresponding positions on an inner side of the eyelash filament A sheet obtained in step S1 with the high-pressure multi-nozzles of the closed thermal spraying device to form the thermal spray eyelash filament A sheet;
performing thermal spraying at corresponding positions on an inner side of the eyelash filament C sheet obtained in step S1 with high-pressure multi-nozzles of the closed thermal spraying device to form the thermal spray eyelash filament C sheet;
widths of thermal spraying banding for thermal spray eyelash filament A/B/C sheets are at least 1 millimeter;
highest point of thermal spraying for the thermal spray eyelash filament A/B/C sheets is 2 millimeters above the fixed double-sided tape;
S3: producing spray coating non-adhesive thermoplastic false eyelashes
overlaying thermal spray eyelash filament A, B, and C sheets in sequence to obtain a semi-finished eyelash D sheet; pressing down the semi-finished eyelash D sheet with a thermal conductive blade of a thermal shaping machine and heating for 1-3 seconds; a part of the semi-finished eyelash D sheet pressed down along the blade forms an eyelash band; cutting off the eyelash filaments waste material along a underside of the eyelash band to obtain the spray coating non-adhesive thermoplastic false eyelashes;
a melting point of a sprayed material on surfaces of the eyelash filament sheets is T, 120° C.≤T≤180° C.; and a temperature of the thermal conductive blade of the thermal conductive shaping machine is set to [T, T+10];
the thermal conductive blade of the thermal shaping machine has a width of 1-3 millimeters.

In some embodiments of the present disclosure, the eyelash silk threads are made of a mixture of PET and PBT materials;
the sprayed material of the closed thermal spraying device is liquid-state polyurethane with a melting point of 120-180 degrees.

In some embodiments of the present disclosure, the thermal spray eyelash filament A sheet is strip eyelash type thermal spray eyelash filament A sheet;
the thermal spray eyelash filament B sheet is strip eyelash type thermal spray eyelash filament B sheet;
the thermal spray eyelash filament C sheet is strip eyelash type thermal spray eyelash filament C sheet;
the semi-finished eyelash D sheet is strip eyelash type semi-finished eyelash D sheet; or
the thermal spray eyelash filament A sheet is a segmented eyelash type thermal spray eyelash filament A sheet;
the thermal spray eyelash filament B sheet is a segmented eyelash type thermal spray eyelash filament B sheet;
the thermal spray eyelash filament C sheet is a segmented eyelash type thermal spray eyelash filament C sheet;
the semi-finished eyelash D sheet is a segmented eyelash type semi-finished eyelash D sheet.

In some embodiments of the present disclosure, the segmented eyelash type semi-finished eyelash D sheet has a width of 2-30 millimeters.

In some embodiments of the present disclosure, a flat and wide silk thread is adhered above the thermal spraying banding for the thermal spray eyelash filament A, B, and C sheets;
the flat and wide silk thread is made of cotton thread, polyester thread, fish thread, eyelash filament produced by PET and PBT mixed material, and polyurethane thread with a melting point lower than that of eyelash filament;
the flat and wide silk thread has a width of 0.7-5 millimeters and a thickness of 0.05-1 millimeters.

In a third aspect, the present application provides a processing method for spray coating non-adhesive thermoplastic false eyelashes, including the following steps:
step1: producing eyelash filament sheets
bonding eyelash filaments with a fixed double-sided tape to obtain the eyelash filament sheets; one side of the fixed double-sided tape is semi-finished false eyelashes, and the other side thereof is an eyelash filaments waste material;
where the eyelash filament sheets consist of eyelash filament A sheet, eyelash filament B sheet, and eyelash filament C sheet;
angles between eyelash filaments of the eyelash filament sheet And the fixed double-sided tape are 45°;
angles between eyelash filaments of the eyelash filament sheet B and the fixed double-sided tape are 90°;
angles between eyelash filaments of the eyelash filament sheet C and the fixed double-sided tape are 135°;
step2: producing flat and wide polyurethane silk thread with a melting point lower than that of eyelash filament
where the flat and wide polyurethane silk thread has a width of 0.7-5 millimeters and a thickness of 0.05-1 millimeters;
step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a thermal conductive blade of a thermal shaping machine or a rolling blade of an ultrasonic machine and heating for 1-3 seconds; a part of the semi-finished eyelash D sheet pressed down along the thermal conductive blade or the rolling blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a heating position of the thermal conductive blade of the thermal shaping machine/a position of the rolling blade of the ultrasonic machine;
a melting point of a sprayed material on surfaces of the eyelash filaments is T, and 120° C.≤T≤180° C.; a temperature of the thermal conductive blade of the thermal conductive shaping machine is set to [T, T+10].

In some embodiments of the present disclosure, the thermal conductive blade of the thermal shaping machine or the rolling blade of the ultrasonic machine has a width of 1-3 millimeters.

Beneficial effects: the processing method for spray coating non-adhesive thermoplastic false eyelashes disclosed in the present disclosure has the following beneficial effects:
1. significantly reducing the amount of various resin adhesives used for bonding, solving the problem of the existing adhesive eyelash band containing a large amount of harmful substances;
2. improving the softness of eyelash band;
3. improving the yield rate of eyelash band, greatly shorting the drying time, and thus increasing production;
4. standardizing a thickness and symmetry of the eyelash band to enhance user comfort;
5. improving aesthetics and realism.

### BRIEF DESCRIPTION OF DRAWINGS

FIG. 1 is a schematic diagram of a device for producing a thermal spray eyelash filament coil.

FIG. 2A is a schematic diagram of strip eyelash type thermal spray eyelash filament A sheet.

FIG. 2B is a schematic diagram of strip eyelash type thermal spray eyelash filament B sheet

FIG. 2C is a schematic diagram of strip eyelash type thermal spray eyelash filament C sheet.

FIG. 2D is a schematic diagram of strip eyelash type thermal spray eyelash filament D sheet.

FIG. 3A is a schematic diagram of a segmented eyelash type thermal spray eyelash filament A sheet.

FIG. 3B is a schematic diagram of a segmented eyelash type thermal spray eyelash filament B sheet.

FIG. 3C is a schematic diagram of a segmented eyelash type thermal spray eyelash filament C sheet.

FIG. 3D is a schematic diagram of a segmented eyelash type thermal spray eyelash filament D sheet.

Numeral reference: 1—flat wide silk thread; 2—thermal spraying banding; 3—fixed double-sided tape; 4—width of segmented eyelash type thermal spray eyelash filament D sheet; 10A—strip eyelash type thermal spray eyelash filament A sheet; 10B—strip eyelash type thermal spray eyelash filament B sheet; 10C—strip eyelash type thermal spray eyelash filament C sheet; 6D—strip eyelash type semi—finished eyelash D sheet; 20A—segmented eyelash type thermal spray eyelash filament A sheet; 20B—segmented eyelash type thermal spray eyelash filament B sheet; 20C—segmented eyelash type thermal spray eyelash filament C sheet; 20D—segmented eyelash type strip eyelash type thermal spray semi-finished eyelash D sheet.

### DESCRIPTION OF EMBODIMENTS

The specific embodiments of the present disclosure will be described in detail below.

The scope disclosed in the present disclosure is defined in a form of a lower limit and an upper limit. The given scope is defined by selecting a lower limit and an upper limit, which define a boundary of a specific range. The range limited by this method can include or exclude end values, and can be combined arbitrarily, that is, any lower limit can be combined with any upper limit to form a range. For example, if a range of 10-50 is listed for a specific parameter, it is understood that ranges of 10-40 and 20-50 are also expected. In addition, if the minimum range values 1 and 2 are listed, and if the maximum range values 3, 4, and 5 are listed, the following ranges can all be expected: 1-3, 1-4, 1-5, 2-3, 2-4, and 2-5. In this application, unless otherwise specified, the range of values “a-b” represents the abbreviated representation of any real number combination between and b, where and b are both real numbers. For example, the numerical range of “0-5” indicates that all real numbers between “0-5” have been listed in this specification, and “0-5” is only an abbreviated representation of these numerical combinations.

Unless otherwise specified, all embodiments of the present application may be combined to form a new technical solution.

Unless otherwise specified, all technical features of this application can be combined to form a new technical solution.

Unless otherwise specified, all steps of this application can be performed sequentially or randomly, in an implementation mode, it is performed in sequence. For example, the method includes steps (a) and (b), indicating that the method may include sequential steps (a) and (b), or sequential steps (b) and (a). For example, the mentioned method may also include step (c), indicating that step (c) can be added to the method in any order. For example, the method may include steps (a), (b), and (c), or steps (a), (c), and (b), or steps (c), (a), and (b), etc.

Unless otherwise specified, terms “including” and “containing” mentioned in this application refer to open or closed forms. For example, terms “including” and “containing” may indicate that they may also include or contain other components not listed or may only include or contain listed components.

If not otherwise specified, the reaction will be carried out under normal temperature and pressure conditions.

Unless otherwise specified, all portions or percentages are weight portions or weight percentages.

In the present disclosure, all substances used are known substances that can be purchased or synthesized by known methods.

In the present disclosure, all devices or equipment used are conventional devices or equipment known in the field and can be purchased.

### Example 1

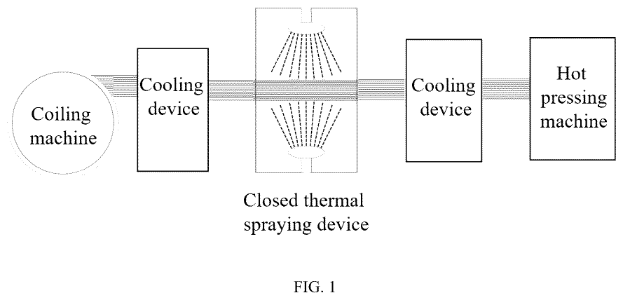

A processing method for spray coating non-adhesive thermoplastic false eyelashes, including the following steps:
(1) preparing a thermal spray eyelash filament coil
as shown in FIG. 1, after a hot pressing machine pulling out eyelash silk threads arranged in a straight line, performing a first cooling treatment, performing a thermal spraying on the eyelash silk threads arranged in a straight line through high-pressure multi-nozzles in a closed thermal spraying device; performing a second cooling treatment after the spraying is completed, and then the thermal spray eyelash filament coil is harvested by a coiling machine;
(2) preparing thermal spray eyelash filaments
cutting, segmenting, and sharpening the thermal spray eyelash filament coil obtained in step (1) to make a bundle of thermal spray eyelash filaments with a length of 5 centimeters;
(3) producing thermal spray eyelash filament sheets
bonding the thermal sprayed eyelash filaments with a fixed double-sided tape 3 to form the thermal spray eyelash filament sheets; one side of the fixed double-sided tape 3 is semi-finished thermal sprayed false eyelashes, and the other side thereof is a thermal sprayed eyelash filaments waste material;
where the thermal spray eyelash filament sheets consist of thermal spray eyelash filament A sheet, thermal spray eyelash filament B sheet, and thermal spray eyelash filament C sheet;
angles between thermal spray eyelash filaments of the thermal spray eyelash filament A sheet and the fixed double-sided tape 3 are 45°;
angles between thermal spray eyelash filaments of the thermal spray eyelash filament B sheet and the fixed double-sided tape 3 are 90°;
angles between thermal spray eyelash filaments of the thermal spray eyelash filament C sheet and the fixed double-sided tape 3 are 135°;
(4) producing spray coating non-adhesive thermoplastic false eyelashes
overlaying thermal spray eyelash filament A, B, and C sheets in sequence to obtain a semi-finished eyelash D sheet, pressing down the semi-finished eyelash D sheet with a thermal conductive blade of a thermal shaping machine and heating for 1 second, a part of the semi-finished eyelash D sheet pressed down along the blade forms an eyelash band; cutting off the thermal sprayed eyelash filaments waste material along a underside of the eyelash band to obtain the spray coating non-adhesive thermoplastic false eyelashes;
a melting point of a sprayed material on surfaces of the eyelash filaments is T, 120° C.≤T≤180° C.; and a temperature of the thermal conductive blade of the thermal conductive shaping machine is set to [T, T+10];
the thermal conductive blade of the thermal shaping machine has a width of 2 millimeters.

In an implementation mode, the eyelash silk threads are made of a mixture of PET and PBT materials;
the sprayed material of the closed thermal spraying device is liquid-state polyurethane with a melting point of 120-180 degrees.

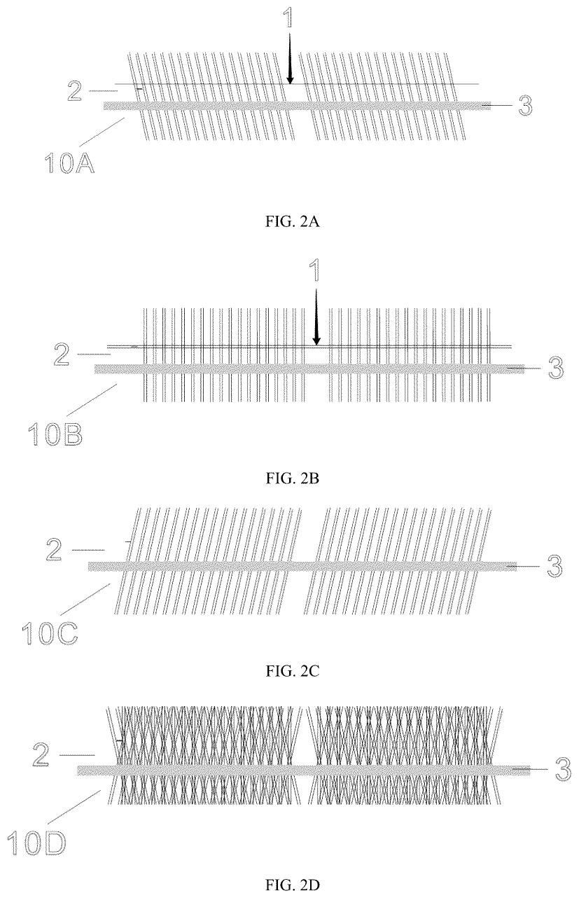

In an implementation mode, as shown in FIGS. 2A to 2D, the thermal spray eyelash filament A sheet is strip eyelash type thermal spray eyelash filament A sheet 10A;
the thermal spray eyelash filament B sheet is strip eyelash type thermal spray eyelash filament B sheet 10B;
the thermal spray eyelash filament C sheet is strip eyelash type thermal spray eyelash filament C sheet 10C;
the semi-finished eyelash D sheet is strip eyelash type semi-finished eyelash D sheet 10D.

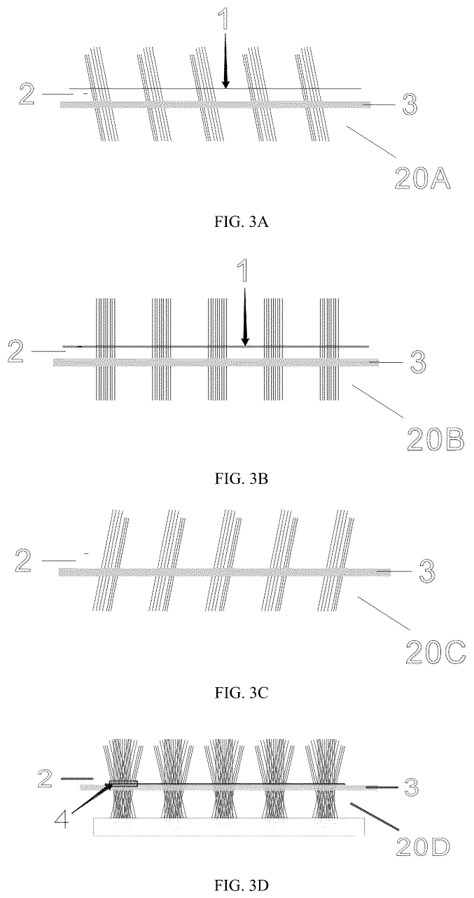

In an implementation mode, as shown in FIGS. 3A-3D, the thermal spray eyelash filament A sheet is a segmented eyelash type thermal spray eyelash filament A sheet 20A;
the thermal spray eyelash filament B sheet is a segmented eyelash type thermal spray eyelash filament B sheet 20B;
the thermal spray eyelash filament C sheet is a segmented eyelash type thermal spray eyelash filament C sheet 20C;
the semi-finished eyelash D sheet is a segmented eyelash type semi-finished eyelash D sheet 20D.

### Example 2

A processing method for spray coating non-adhesive thermoplastic false eyelashes, including the following steps:
(1) preparing a thermal spray eyelash filament coil
as shown in FIG. 1, after a hot pressing machine pulling out eyelash silk threads arranged in a straight line, performing a first cooling treatment, performing a thermal spraying on the eyelash silk threads arranged in a straight line through high-pressure multi-nozzles in a closed thermal spraying device; performing a second cooling treatment after the spraying is completed, and then the thermal spray eyelash filament coil is harvested by a coiling machine;
(2) preparing thermal spray eyelash filaments
cutting, segmenting, and sharpening the thermal spray eyelash filament coil obtained in step (1) to make a bundle of thermal spray eyelash filaments with a length of 5 centimeters;
(3) producing thermal spray eyelash filament sheets
bonding the thermal sprayed eyelash filaments with a fixed double-sided tape 3 to form the thermal spray eyelash filament sheets; one side of the fixed double-sided tape 3 is semi-finished thermal sprayed false eyelashes, and the other side thereof is a thermal sprayed eyelash filaments waste material;
where the thermal spray eyelash filament sheets consist of thermal spray eyelash filament A sheet, thermal spray eyelash filament B sheet, and thermal spray eyelash filament C sheet;
angles between thermal spray eyelash filaments of the thermal spray eyelash filament A sheet and the fixed double-sided tape 3 are 45°;
angles between thermal spray eyelash filaments of the thermal spray eyelash filament B sheet and the fixed double-sided tape 3 are 90°;
angles between thermal spray eyelash filaments of the thermal spray eyelash filament C sheet and the fixed double-sided tape 3 are 135°;
(4) producing spray coating non-adhesive thermoplastic false eyelashes
overlaying thermal spray eyelash filament A, B, and C sheets in sequence to obtain a semi-finished eyelash D sheet, pressing down the semi-finished eyelash D sheet with a thermal conductive blade of a thermal shaping machine and heating for 3 seconds, a part of the semi-finished eyelash D sheet pressed down along the blade forms an eyelash band; cutting off the thermal sprayed eyelash filaments waste material along a underside of the eyelash band to obtain the spray coating non-adhesive thermoplastic false eyelashes;
a melting point of a sprayed material on surfaces of the eyelash filaments is T, 120° C.≤T≤180° C.; and a temperature of the thermal conductive blade of the thermal conductive shaping machine is set to [T, T+10];
the thermal conductive blade of the thermal shaping machine has a width of 1 millimeter.

In an implementation mode, the eyelash silk threads are made of a mixture of PET and PBT materials;
the sprayed material of the closed thermal spraying device is liquid-state polyurethane with a melting point of 120-180 degrees.

In an implementation mode, as shown in FIGS. 2A to 2D, the thermal spray eyelash filament A sheet is strip eyelash type thermal spray eyelash filament A sheet 10A;
the thermal spray eyelash filament B sheet is strip eyelash type thermal spray eyelash filament B sheet 10B;
the thermal spray eyelash filament C sheet is strip eyelash type thermal spray eyelash filament C sheet 10C;
the semi-finished eyelash D sheet is strip eyelash type semi-finished eyelash D sheet 10D.

In an implementation mode, as shown in FIGS. 3A-3D, the thermal spray eyelash filament A sheet is a segmented eyelash type thermal spray eyelash filament A sheet 20A;
the thermal spray eyelash filament B sheet is a segmented eyelash type thermal spray eyelash filament B sheet 20B;
the thermal spray eyelash filament C sheet is a segmented eyelash type thermal spray eyelash filament C sheet 20C;
the semi-finished eyelash D sheet is a segmented eyelash type semi-finished eyelash D sheet 20D.

### Example 3

A processing method for spray coating non-adhesive thermoplastic false eyelashes, including the following steps:
(1) preparing a thermal spray eyelash filament coil
as shown in FIG. 1, after a hot pressing machine pulling out eyelash silk threads arranged in a straight line, performing a first cooling treatment, performing a thermal spraying on the eyelash silk threads arranged in a straight line through high-pressure multi-nozzles in a closed thermal spraying device; performing a second cooling treatment after the spraying is completed, and then the thermal spray eyelash filament coil is harvested by a coiling machine;
(2) preparing thermal spray eyelash filaments
cutting, segmenting, and sharpening the thermal spray eyelash filament coil obtained in step (1) to make a bundle of thermal spray eyelash filaments with a length of 5 centimeters;
(3) producing thermal spray eyelash filament sheets
bonding the thermal sprayed eyelash filaments with a fixed double-sided tape 3 to form the thermal spray eyelash filament sheets; one side of the fixed double-sided tape 3 is semi-finished thermal sprayed false eyelashes, and the other side thereof is a thermal sprayed eyelash filaments waste material;
where the thermal spray eyelash filament sheets consist of thermal spray eyelash filament A sheet, thermal spray eyelash filament B sheet, and thermal spray eyelash filament C sheet;
angles between thermal spray eyelash filaments of the thermal spray eyelash filament A sheet and the fixed double-sided tape 3 are 45°;
angles between thermal spray eyelash filaments of the thermal spray eyelash filament B sheet and the fixed double-sided tape 3 are 90°;
angles between thermal spray eyelash filaments of the thermal spray eyelash filament C sheet and the fixed double-sided tape 3 are 135°;
(4) producing spray coating non-adhesive thermoplastic false eyelashes
overlaying thermal spray eyelash filament A, B, and C sheets in sequence to obtain a semi-finished eyelash D sheet, pressing down the semi-finished eyelash D sheet with a thermal conductive blade of a thermal shaping machine and heating for 2 seconds, a part of the semi-finished eyelash D sheet pressed down along the blade forms an eyelash band; cutting off the thermal sprayed eyelash filaments waste material along a underside of the eyelash band to obtain the spray coating non-adhesive thermoplastic false eyelashes;
a melting point of a sprayed material on surfaces of the eyelash filaments is T, 120° C.≤T≤180° C.; and a temperature of the thermal conductive blade of the thermal conductive shaping machine is set to [T, T+10];
the thermal conductive blade of the thermal shaping machine has a width of 3 millimeters.

In an implementation mode, the eyelash silk threads are made of a mixture of PET and PBT materials;
the sprayed material of the closed thermal spraying device is liquid-state polyurethane with a melting point of 120-180 degrees.

In an implementation mode, as shown in FIGS. 2A to 2D, the thermal spray eyelash filament A sheet is strip eyelash type thermal spray eyelash filament A sheet 10A;
the thermal spray eyelash filament B sheet is strip eyelash type thermal spray eyelash filament B sheet 10B;
the thermal spray eyelash filament C sheet is strip eyelash type thermal spray eyelash filament C sheet 10C;
the semi-finished eyelash D sheet is strip eyelash type semi-finished eyelash D sheet 10D.

In an implementation mode, as shown in FIGS. 3A-3D, the thermal spray eyelash filament A sheet is a segmented eyelash type thermal spray eyelash filament A sheet 20A;
the thermal spray eyelash filament B sheet is a segmented eyelash type thermal spray eyelash filament B sheet 20B;
the thermal spray eyelash filament C sheet is a segmented eyelash type thermal spray eyelash filament C sheet 20C;
the semi-finished eyelash D sheet is a segmented eyelash type semi-finished eyelash D sheet 20D.

### Example 4

A processing method for spray coating non-adhesive thermoplastic false eyelashes, including the following steps:
S1: producing eyelash filament sheets
bonding eyelash filaments with a fixed double-sided tape 3 to obtain the eyelash filament sheets; one side of the fixed double-sided tape 3 is semi-finished false eyelashes, and the other side thereof is an eyelash filaments waste material;
where the eyelash filament sheets consist of spray eyelash filament A sheet, spray eyelash filament B sheet, and spray eyelash filament C sheet;
angles between eyelash filaments of the eyelash filament A sheet and the fixed double-sided tape 3 are 45°;
angles between eyelash filaments of the eyelash filament B sheet and the fixed double-sided tape 3 are 90°;
angles between eyelash filaments of the eyelash filament C sheet and the fixed double-sided tape 3 are 135°;
S2: producing thermal spray eyelash filament A/B/C sheets
performing thermal spraying at corresponding positions on two sides of the eyelash filament B sheet obtained in step S1 with high-pressure multi-nozzles of a closed thermal spraying device to form the thermal spray eyelash filament B sheet;
performing thermal spraying at corresponding positions on an inner side of the eyelash filament A sheet obtained in step S1 with the high-pressure multi-nozzles of the closed thermal spraying device to form the thermal spray eyelash filament A sheet;
performing thermal spraying at corresponding positions on an inner side of the eyelash filament C sheet obtained in step S1 with high-pressure multi-nozzles of the closed thermal spraying device to form the thermal spray eyelash filament C sheet;
widths of thermal spraying banding 2 for thermal spray eyelash filament A/B/C sheets are 3 millimeters;
highest point of thermal spraying for the thermal spray eyelash filament A/B/C sheets is 2 millimeters above the fixed double-sided tape 3;
S3: producing spray coating non-adhesive thermoplastic false eyelashes
overlaying thermal spray eyelash filament A, B, and C sheets in sequence to obtain a semi-finished eyelash D sheet; pressing down the semi-finished eyelash D sheet with a thermal conductive blade of a thermal shaping machine and heating for 1 second; a part of the semi-finished eyelash D sheet pressed down along the blade forms an eyelash band; cutting off the eyelash filaments waste material along a underside of the eyelash band to obtain the spray coating non-adhesive thermoplastic false eyelashes;
a melting point of a sprayed material on surfaces of the eyelash filament sheets is T, 120° C.≤T≤180° C.; and a temperature of the thermal conductive blade of the thermal conductive shaping machine is set to [T, T+10];
the thermal conductive blade of the thermal shaping machine has a width of 1 millimeter.

In an implementation mode, the eyelash silk threads are made of a mixture of PET and PBT materials;
the sprayed material of the closed thermal spraying device is liquid-state polyurethane with a melting point of 120-180 degrees.

In an implementation mode, as shown in FIGS. 2A to 2D, the thermal spray eyelash filament A sheet is strip eyelash type thermal spray eyelash filament A sheet 10A;
the thermal spray eyelash filament B sheet is strip eyelash type thermal spray eyelash filament B sheet 10B;
the thermal spray eyelash filament C sheet is strip eyelash type thermal spray eyelash filament C sheet 10C;
the semi-finished eyelash D sheet is strip eyelash type semi-finished eyelash D sheet 10D.

In an implementation mode, as shown in FIGS. 3A-3D, the thermal spray eyelash filament A sheet is a segmented eyelash type thermal spray eyelash filament A sheet 20A;
the thermal spray eyelash filament B sheet is a segmented eyelash type thermal spray eyelash filament B sheet 20B;
the thermal spray eyelash filament C sheet is a segmented eyelash type thermal spray eyelash filament C sheet 20C;
the semi-finished eyelash D sheet is a segmented eyelash type semi-finished eyelash D sheet 20D.

In an implementation mode, the segmented eyelash type semi-finished eyelash D sheet has a width 4 of 2 millimeters.

In an implementation mode, a flat and wide silk thread 1 is adhered above the thermal spraying banding 2 for the thermal spray eyelash filament A, B, and C sheets;
the flat and wide silk thread 1 is made of cotton thread;
the flat and wide silk thread 1 has a width of 0.7 millimeters and a thickness of 0.05 millimeters.

### Example 5

A processing method for spray coating non-adhesive thermoplastic false eyelashes, including the following steps:
S1: producing eyelash filament sheets
bonding eyelash filaments with a fixed double-sided tape 3 to obtain the eyelash filament sheets; one side of the fixed double-sided tape 3 is semi-finished false eyelashes, and the other side thereof is an eyelash filaments waste material;
where the eyelash filament sheets consist of spray eyelash filament A sheet, spray eyelash filament B sheet, and spray eyelash filament C sheet;
angles between eyelash filaments of the eyelash filament A sheet and the fixed double-sided tape 3 are 45°;
angles between eyelash filaments of the eyelash filament B sheet and the fixed double-sided tape 3 are 90°;
angles between eyelash filaments of the eyelash filament C sheet and the fixed double-sided tape 3 are 135°;
S2: producing thermal spray eyelash filament A/B/C sheets
performing thermal spraying at corresponding positions on two sides of the eyelash filament B sheet obtained in step S1 with high-pressure multi-nozzles of a closed thermal spraying device to form the thermal spray eyelash filament B sheet;
performing thermal spraying at corresponding positions on an inner side of the eyelash filament A sheet obtained in step S1 with the high-pressure multi-nozzles of the closed thermal spraying device to form the thermal spray eyelash filament A sheet;
performing thermal spraying at corresponding positions on an inner side of the eyelash filament C sheet obtained in step S1 with high-pressure multi-nozzles of the closed thermal spraying device to form the thermal spray eyelash filament C sheet;
widths of thermal spraying banding 2 for thermal spray eyelash filament A/B/C sheets are 1 millimeter;
highest point of thermal spraying for the thermal spray eyelash filament A/B/C sheets is 2 millimeters above the fixed double-sided tape 3;
S3: producing spray coating non-adhesive thermoplastic false eyelashes
overlaying thermal spray eyelash filament A, B, and C sheets in sequence to obtain a semi-finished eyelash D sheet; pressing down the semi-finished eyelash D sheet with a thermal conductive blade of a thermal shaping machine and heating for 3 seconds; a part of the semi-finished eyelash D sheet pressed down along the blade forms an eyelash band; cutting off the eyelash filaments waste material along a underside of the eyelash band to obtain the spray coating non-adhesive thermoplastic false eyelashes;
a melting point of a sprayed material on surfaces of the eyelash filament sheets is T, 120° C.≤T≤180° C.; and a temperature of the thermal conductive blade of the thermal conductive shaping machine is set to [T, T+10];
the thermal conductive blade of the thermal shaping machine has a width of 3 millimeters.

In an implementation mode, the eyelash silk threads are made of a mixture of PET and PBT materials;
the sprayed material of the closed thermal spraying device is liquid-state polyurethane with a melting point of 120-180 degrees.

In an implementation mode, as shown in FIGS. 2A to 2D, the thermal spray eyelash filament A sheet is strip eyelash type thermal spray eyelash filament A sheet 10A;
the thermal spray eyelash filament B sheet is strip eyelash type thermal spray eyelash filament B sheet 10B;
the thermal spray eyelash filament C sheet is strip eyelash type thermal spray eyelash filament C sheet 10C;
the semi-finished eyelash D sheet is strip eyelash type semi-finished eyelash D sheet 10D.

In an implementation mode, as shown in FIGS. 3A-3D, the thermal spray eyelash filament A sheet is a segmented eyelash type thermal spray eyelash filament A sheet 20A;
the thermal spray eyelash filament B sheet is a segmented eyelash type thermal spray eyelash filament B sheet 20B;
the thermal spray eyelash filament C sheet is a segmented eyelash type thermal spray eyelash filament C sheet 20C;
the semi-finished eyelash D sheet is a segmented eyelash type semi-finished eyelash D sheet 20D.

In an implementation mode, the segmented eyelash type semi-finished eyelash D sheet has a width 4 of 30 millimeters.

In an implementation mode, a flat and wide silk thread 1 is adhered above the thermal spraying banding 2 for the thermal spray eyelash filament A, B, and C sheets;
the flat and wide silk thread 1 is made of polyester thread;
the flat and wide silk thread 1 has a width of 5 millimeters and a thickness of 1 millimeter.

### Example 6

A processing method for spray coating non-adhesive thermoplastic false eyelashes, including the following steps:
S1: producing eyelash filament sheets
bonding eyelash filaments with a fixed double-sided tape 3 to obtain the eyelash filament sheets; one side of the fixed double-sided tape 3 is semi-finished false eyelashes, and the other side thereof is an eyelash filaments waste material;
where the eyelash filament sheets consist of spray eyelash filament A sheet, spray eyelash filament B sheet, and spray eyelash filament C sheet;
angles between eyelash filaments of the eyelash filament A sheet and the fixed double-sided tape 3 are 45°;
angles between eyelash filaments of the eyelash filament B sheet and the fixed double-sided tape 3 are 90°;
angles between eyelash filaments of the eyelash filament C sheet and the fixed double-sided tape 3 are 135°;
S2: producing thermal spray eyelash filament A/B/C sheets
performing thermal spraying at corresponding positions on two sides of the eyelash filament B sheet obtained in step S1 with high-pressure multi-nozzles of a closed thermal spraying device to form the thermal spray eyelash filament B sheet;
performing thermal spraying at corresponding positions on an inner side of the eyelash filament A sheet obtained in step S1 with the high-pressure multi-nozzles of the closed thermal spraying device to form the thermal spray eyelash filament A sheet;
performing thermal spraying at corresponding positions on an inner side of the eyelash filament C sheet obtained in step S1 with high-pressure multi-nozzles of the closed thermal spraying device to form the thermal spray eyelash filament C sheet;
widths of thermal spraying banding 2 for thermal spray eyelash filament A/B/C sheets are 2 millimeters;
highest point of thermal spraying for the thermal spray eyelash filament A/B/C sheets is 2 millimeters above the fixed double-sided tape 3;
S3: producing spray coating non-adhesive thermoplastic false eyelashes
overlaying thermal spray eyelash filament A, B, and C sheets in sequence to obtain a semi-finished eyelash D sheet; pressing down the semi-finished eyelash D sheet with a thermal conductive blade of a thermal shaping machine and heating for 2 seconds; a part of the semi-finished eyelash D sheet pressed down along the blade forms an eyelash band; cutting off the eyelash filaments waste material along a underside of the eyelash band to obtain the spray coating non-adhesive thermoplastic false eyelashes;
a melting point of a sprayed material on surfaces of the eyelash filament sheets is T, 120° C.≤T≤180° C.; and a temperature of the thermal conductive blade of the thermal conductive shaping machine is set to [T, T+10];
the thermal conductive blade of the thermal shaping machine has a width of 2 millimeters.

In an implementation mode, the eyelash silk threads are made of a mixture of PET and PBT materials;
the sprayed material of the closed thermal spraying device is liquid-state polyurethane with a melting point of 120-180 degrees.

In an implementation mode, as shown in FIGS. 2A to 2D, the thermal spray eyelash filament A sheet is strip eyelash type thermal spray eyelash filament A sheet 10A;
the thermal spray eyelash filament B sheet is strip eyelash type thermal spray eyelash filament B sheet 10B;
the thermal spray eyelash filament C sheet is strip eyelash type thermal spray eyelash filament C sheet 10C;
the semi-finished eyelash D sheet is strip eyelash type semi-finished eyelash D sheet 10D.

In an implementation mode, as shown in FIGS. 3A-3D, the thermal spray eyelash filament A sheet is a segmented eyelash type thermal spray eyelash filament A sheet 20A;
the thermal spray eyelash filament B sheet is a segmented eyelash type thermal spray eyelash filament B sheet 20B;
the thermal spray eyelash filament C sheet is a segmented eyelash type thermal spray eyelash filament C sheet 20C;
the semi-finished eyelash D sheet is a segmented eyelash type semi-finished eyelash D sheet 20D.

In an implementation mode, the segmented eyelash type semi-finished eyelash D sheet has a width 4 of 10 millimeters.

In an implementation mode, a flat and wide silk thread 1 is attached above the thermal spraying banding 2 for the thermal spray eyelash filament A, B, and C sheets;
the flat and wide silk thread 1 is made of fish thread; in an implementation mode, the flat and wide silk thread 1 is eyelash filament produced by PET and PBT mixed material; in an implementation mode, the flat and wide silk thread 1 is a polyurethane thread with a melting point lower than that of eyelash filament;
the flat and wide silk thread 1 has a width of 2 millimeters and a thickness of 0.5 millimeters.

### Example 7

A processing method for spray coating non-adhesive thermoplastic false eyelashes, including the following steps:
step1: producing eyelash filament sheets
bonding eyelash filaments with a fixed double-sided tape 3 to obtain the eyelash filament sheets; one side of the fixed double-sided tape 3 is semi-finished false eyelashes, and the other side thereof is an eyelash filaments waste material;
where the eyelash filament sheets consist of eyelash filament A sheet, eyelash filament B sheet, and eyelash filament C sheet;
angles between eyelash filaments of the eyelash filament sheet And the fixed double-sided tape 3 are 45°;
angles between eyelash filaments of the eyelash filament sheet B and the fixed double-sided tape 3 are 90°;
angles between eyelash filaments of the eyelash filament sheet C and the fixed double-sided tape 3 are 135°;
step2: producing flat and wide polyurethane silk thread 1 with a melting point lower than that of eyelash filament
where the flat and wide polyurethane silk thread 1 has a width of 0.7 millimeters and a thickness of 0.05 millimeters;
step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a thermal conductive blade of a thermal shaping machine for 1 second; a part of the semi-finished eyelash D sheet pressed down along the thermal conductive blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a heating position of the thermal conductive blade of the thermal shaping machine;
a melting point of a sprayed material on surfaces of the eyelash filaments is T, and 120° C.≤T≤180° C.; a temperature of the thermal conductive blade of the thermal conductive shaping machine is set to [T, T+10].

In an implementation mode, the thermal conductive blade of the thermal shaping machine has a width of 1 millimeter.

### Example 8

A processing method for spray coating non-adhesive thermoplastic false eyelashes, including the following steps:
step1: producing eyelash filament sheets
bonding eyelash filaments with a fixed double-sided tape 3 to obtain the eyelash filament sheets; one side of the fixed double-sided tape 3 is semi-finished false eyelashes, and the other side thereof is an eyelash filaments waste material;
where the eyelash filament sheets consist of eyelash filament A sheet, eyelash filament B sheet, and eyelash filament C sheet;
angles between eyelash filaments of the eyelash filament sheet And the fixed double-sided tape 3 are 45°;
angles between eyelash filaments of the eyelash filament sheet B and the fixed double-sided tape 3 are 90°;
angles between eyelash filaments of the eyelash filament sheet C and the fixed double-sided tape 3 are 135°;
step2: producing flat and wide polyurethane silk thread 1 with a melting point lower than that of eyelash filament
where the flat and wide polyurethane silk thread 1 has a width of 5 millimeters and a thickness of 1 millimeter;
step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a thermal conductive blade of a thermal shaping machine and heating for 3 seconds; a part of the semi-finished eyelash D sheet pressed down along the thermal conductive blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a heating position of the thermal conductive blade of the thermal shaping machine;
a melting point of a sprayed material on surfaces of the eyelash filaments is T, and 120° C.≤T≤180° C.; a temperature of the thermal conductive blade of the thermal conductive shaping machine is set to [T, T+10].

In an implementation mode, the thermal conductive blade of the thermal shaping machine has a width of 3 millimeters.

### Example 9

A processing method for spray coating non-adhesive thermoplastic false eyelashes, including the following steps:
step1: producing eyelash filament sheets
bonding eyelash filaments with a fixed double-sided tape 3 to obtain the eyelash filament sheets; one side of the fixed double-sided tape 3 is semi-finished false eyelashes, and the other side thereof is an eyelash filaments waste material;
where the eyelash filament sheets consist of eyelash filament A sheet, eyelash filament B sheet, and eyelash filament C sheet;
angles between eyelash filaments of the eyelash filament sheet And the fixed double-sided tape 3 are 45°;
angles between eyelash filaments of the eyelash filament sheet B and the fixed double-sided tape 3 are 90°;
angles between eyelash filaments of the eyelash filament sheet C and the fixed double-sided tape 3 are 135°;
step2: producing flat and wide polyurethane silk thread 1 with a melting point lower than that of eyelash filament
where the flat and wide polyurethane silk thread 1 has a width of 2 millimeters and a thickness of 0.5 millimeter;
step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a thermal conductive blade of a thermal shaping machine and heating for 2 seconds; a part of the semi-finished eyelash D sheet pressed down along the thermal conductive blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a heating position of the thermal conductive blade of the thermal shaping machine
a melting point of a sprayed material on surfaces of the eyelash filaments is T, and 120° C.≤T≤180° C.; a temperature of the thermal conductive blade of the thermal conductive shaping machine is set to [T, T+10].

In an implementation mode, the thermal conductive blade of the thermal shaping machine has a width of 2 millimeters.

In an implementation mode, step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a rolling blade of an ultrasonic machine and heating for 1 second; a part of the semi-finished eyelash D sheet pressed down along the rolling blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a position of the rolling blade of the ultrasonic machine;
a melting point of a sprayed material on surfaces of the eyelash filaments is T, and 120° C.≤T≤180° C.; a temperature of the thermal conductive blade of the thermal conductive shaping machine is set to [T, T+10].

In an implementation mode, the rolling blade of the ultrasonic machine has a width of 1 millimeter.

In an implementation mode, step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a rolling blade of an ultrasonic machine and heating for 3 seconds; a part of the semi-finished eyelash D sheet pressed down along the rolling blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a position of the rolling blade of the ultrasonic machine;
a melting point of a sprayed material on surfaces of the eyelash filaments is T, and 120° C.≤T≤180° C.; a temperature of the thermal conductive blade of the thermal conductive shaping machine is set to [T, T+10].

In an implementation mode, the rolling blade of the ultrasonic machine has a width of 3 millimeters.

In an implementation mode, step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a rolling blade of an ultrasonic machine and heating for 2 seconds; a part of the semi-finished eyelash D sheet pressed down along the rolling blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a position of the rolling blade of the ultrasonic machine;
a melting point of a sprayed material on surfaces of the eyelash filaments is T, and 120° C.≤T≤180° C.; a temperature of the thermal conductive blade of the thermal conductive shaping machine is set to [T, T+10].

In an implementation mode, the rolling blade of the ultrasonic machine has a width of 2 millimeters.

The above provides a detailed explanation of the embodiments of the present disclosure. However, the present disclosure is not limited to the above embodiments, and various changes can be made within the knowledge scope of those skilled in the relevant technical field without departing from the scope of the present disclosure.

What is claimed is:

1. A processing method for spray coating non-adhesive thermoplastic false eyelashes, comprising the following steps:
(1) preparing a thermal spray eyelash filament coil
after a hot pressing machine pulling out eyelash silk threads arranged in a straight line, performing a first cooling treatment, performing a thermal spraying on the eyelash silk threads arranged in a straight line through high-pressure multi-nozzles in a closed thermal spraying device; performing a second cooling treatment after the spraying is completed, and then the thermal spray eyelash filament coil is harvested by a coiling machine;
(2) preparing thermal spray eyelash filaments
cutting, segmenting, and sharpening the thermal spray eyelash filament coil obtained in step (1) to make a bundle of thermal spray eyelash filaments with a length of 5 centimeters;
(3) producing thermal spray eyelash filament sheets
bonding the thermal sprayed eyelash filaments with a fixed double-sided tape to form the thermal spray eyelash filament sheets; one side of the fixed double-sided tape is semi-finished thermal sprayed false eyelashes, and the other side thereof is a thermal sprayed eyelash filaments waste material;
wherein the thermal spray eyelash filament sheets consist of thermal spray eyelash filament A sheet, thermal spray eyelash filament B sheet, and thermal spray eyelash filament C sheet;
angles between thermal spray eyelash filaments of the thermal spray eyelash filament A sheet and the fixed double-sided tape are 45°;
angles between thermal spray eyelash filaments of the thermal spray eyelash filament B sheet and the fixed double-sided tape are 90°;
angles between thermal spray eyelash filaments of the thermal spray eyelash filament C sheet and the fixed double-sided tape are 135°;
(4) producing spray coating non-adhesive thermoplastic false eyelashes
overlaying thermal spray eyelash filament A, B, and C sheets in sequence to obtain a semi-finished eyelash D sheet, pressing down the semi-finished eyelash D sheet with a thermal conductive blade of a thermal shaping machine and heating for 1-3 seconds, a part of the semi-finished eyelash D sheet pressed down along the blade forms an eyelash band;
cutting off the thermal sprayed eyelash filaments waste material along a underside of the eyelash band to obtain the spray coating non-adhesive thermoplastic false eyelashes;
a melting point of a sprayed material on surfaces of the eyelash filaments is T, 120° C.≤T≤180° C.; and a temperature of the thermal conductive blade of the thermal conductive shaping machine is set to [T, T+10];
the thermal conductive blade of the thermal shaping machine has a width of 1-3 millimeters.

2. The processing method for spray coating non-adhesive thermoplastic false eyelashes according to claim 1, wherein the eyelash silk threads are made of a mixture of PET and PBT materials;
the sprayed material of the closed thermal spraying device is liquid-state polyurethane with a melting point of 120-180 degrees.

3. The processing method for spray coating non-adhesive thermoplastic false eyelashes according to claim 1, wherein the thermal spray eyelash filament A sheet is strip eyelash type thermal spray eyelash filament A sheet;
the thermal spray eyelash filament B sheet is strip eyelash type thermal spray eyelash filament B sheet;
the thermal spray eyelash filament C sheet is strip eyelash type thermal spray eyelash filament C sheet;
the semi-finished eyelash D sheet is strip eyelash type semi-finished eyelash D sheet; or
the thermal spray eyelash filament A sheet is a segmented eyelash type thermal spray eyelash filament A sheet;
the thermal spray eyelash filament B sheet is a segmented eyelash type thermal spray eyelash filament B sheet;
the thermal spray eyelash filament C sheet is a segmented eyelash type thermal spray eyelash filament C sheet;
the semi-finished eyelash D sheet is a segmented eyelash type semi-finished eyelash D sheet.

4. A processing method for spray coating non-adhesive thermoplastic false eyelashes, comprising the following steps:
S1: producing eyelash filament sheets
bonding eyelash filaments with a fixed double-sided tape to obtain the eyelash filament sheets; one side of the fixed double-sided tape is semi-finished false eyelashes, and the other side thereof is an eyelash filaments waste material;
wherein the eyelash filament sheets consist of spray eyelash filament A sheet, spray eyelash filament B sheet, and spray eyelash filament C sheet;
angles between eyelash filaments of the eyelash filament A sheet and the fixed double-sided tape are 45°;
angles between eyelash filaments of the eyelash filament B sheet and the fixed double-sided tape are 90°;
angles between eyelash filaments of the eyelash filament C sheet and the fixed double-sided tape are 135°;
S2: producing thermal spray eyelash filament A/B/C sheets
performing thermal spraying at corresponding positions on two sides of the eyelash filament B sheet obtained in step S1 with high-pressure multi-nozzles of a closed thermal spraying device to form the thermal spray eyelash filament B sheet;
performing thermal spraying at corresponding positions on an inner side of the eyelash filament A sheet obtained in step S1 with the high-pressure multi-nozzles of the closed thermal spraying device to form the thermal spray eyelash filament A sheet;
performing thermal spraying at corresponding positions on an inner side of the eyelash filament C sheet obtained in step S1 with high-pressure multi-nozzles of the closed thermal spraying device to form the thermal spray eyelash filament C sheet;
widths of thermal spraying banding for thermal spray eyelash filament A/B/C sheets are at least 1 millimeter;
highest point of thermal spraying for the thermal spray eyelash filament A/B/C sheets is 2 millimeters above the fixed double-sided tape;
S3: producing spray coating non-adhesive thermoplastic false eyelashes
overlaying thermal spray eyelash filament A, B, and C sheets in sequence to obtain a semi-finished eyelash D sheet; pressing down the semi-finished eyelash D sheet with a thermal conductive blade of a thermal shaping machine and heating for 1-3 seconds; a part of the semi-finished eyelash D sheet pressed down along the blade forms an eyelash band; cutting off the eyelash filaments waste material along a underside of the eyelash band to obtain the spray coating non-adhesive thermoplastic false eyelashes;
a melting point of a sprayed material on surfaces of the eyelash filament sheets is T, 120° C.≤T≤180° C.; and a temperature of the thermal conductive blade of the thermal conductive shaping machine is set to [T, T+10];
the thermal conductive blade of the thermal shaping machine has a width of 1-3 millimeters.

5. The processing method for spray coating non-adhesive thermoplastic false eyelashes according to claim 4, wherein the eyelash silk threads are made of a mixture of PET and PBT materials;
the sprayed material of the closed thermal spraying device is liquid-state polyurethane with a melting point of 120-180 degrees.

6. The processing method for spray coating non-adhesive thermoplastic false eyelashes according to claim 4, wherein the thermal spray eyelash filament A sheet is strip eyelash type thermal spray eyelash filament A sheet;
the thermal spray eyelash filament B sheet is strip eyelash type thermal spray eyelash filament B sheet;
the thermal spray eyelash filament C sheet is strip eyelash type thermal spray eyelash filament C sheet;
the semi-finished eyelash D sheet is strip eyelash type semi-finished eyelash D sheet; or
the thermal spray eyelash filament A sheet is a segmented eyelash type thermal spray eyelash filament A sheet;
the thermal spray eyelash filament B sheet is a segmented eyelash type thermal spray eyelash filament B sheet;
the thermal spray eyelash filament C sheet is a segmented eyelash type thermal spray eyelash filament C sheet;
the semi-finished eyelash D sheet is a segmented eyelash type semi-finished eyelash D sheet.

7. The processing method for spray coating non-adhesive thermoplastic false eyelashes according to claim 6, wherein the segmented eyelash type semi-finished eyelash D sheet has a width of 2-30 millimeters.

8. The processing method for spray coating non-adhesive thermoplastic false eyelashes according to claim 6, wherein a flat and wide silk thread is adhered above the thermal spraying banding for the thermal spray eyelash filament A, B, and C sheets;
the flat and wide silk thread is made of cotton thread, polyester thread, fish thread, eyelash filament produced by PET and PBT mixed material, and polyurethane thread with a melting point lower than that of eyelash filament;
the flat and wide silk thread has a width of 0.7-5 millimeters and a thickness of 0.05-1 millimeters.

9. A processing method for spray coating non-adhesive thermoplastic false eyelashes, comprising the following steps:
step1: producing eyelash filament sheets
bonding eyelash filaments with a fixed double-sided tape to obtain the eyelash filament sheets; one side of the fixed double-sided tape is semi-finished false eyelashes, and the other side thereof is an eyelash filaments waste material;
wherein the eyelash filament sheets consist of eyelash filament A sheet, eyelash filament B sheet, and eyelash filament C sheet;
angles between eyelash filaments of the eyelash filament sheet And the fixed double-sided tape are 45°;
angles between eyelash filaments of the eyelash filament sheet B and the fixed double-sided tape are 90°;
angles between eyelash filaments of the eyelash filament sheet C and the fixed double-sided tape are 135°;
step2: producing flat and wide polyurethane silk thread with a melting point lower than that of eyelash filament
wherein the flat and wide polyurethane silk thread has a width of 0.7-5 millimeters and a thickness of 0.05-1 millimeters;
step3: producing spray coating non-adhesive thermoplastic false eyelashes
overlaying spray eyelash filament A sheet, one flat and wide polyurethane silk thread, spray eyelash filament B sheet, another flat and wide polyurethane silk thread, and spray eyelash filament C sheet in sequence to obtain a semi-finished eyelash D sheet, pressing down the semi-finished eyelash D sheet with a thermal conductive blade of a thermal shaping machine or a rolling blade of an ultrasonic machine and heating for 1-3 seconds; a part of the semi-finished eyelash D sheet pressed down along the thermal conductive blade or the rolling blade forms an eyelash band; cutting off the eyelash filaments waste material along a underside of the eyelash band to obtain the spray coating non-adhesive thermoplastic false eyelashes;
a position of the flat and wide polyurethane silk thread is adapted to a heating position of the thermal conductive blade of the thermal shaping machine/a position of the rolling blade of the ultrasonic machine;
a melting point of a sprayed material on surfaces of the eyelash filaments is T, and 120 C.≤T≤180° C.; a temperature of the thermal conductive blade of the thermal conductive shaping machine is set to [T, T+10].

10. The processing method for spray coating non-adhesive thermoplastic false eyelashes according to claim 9, wherein the thermal conductive blade of the thermal shaping machine or the rolling blade of the ultrasonic machine has a width of 1-3 millimeters.
